(19) United States
(12) Patent Application Publication
(10) Pub. No.: US 2024/0375296 A1
(43) Pub. Date: Nov. 14, 2024

(54) Pneumatic Linear Actuator

(71) Applicant: FerRobotics Compliant Robot Technology GmbH, Linz (AT)

(72) Inventor: Ronald Naderer, Oberneukirchen (AT)

(21) Appl. No.: 18/557,350

(22) PCT Filed: Apr. 29, 2022
(86) PCT No.: PCT/EP2022/061487

§ 371 Date: Feb. 27, 2024

(30) Foreign Application Priority Data
Apr. 29, 2021 (DE) 10 2021 111 064.5

(51) Int. Cl. B25J 15/06; B25J 15/00; F15B 15/14

(52) U.S. Cl. CPC B25J 15/0683; B25J 15/0019; F15B 15/1461; F15B 15/1476

(57) ABSTRACT

The invention relates to a pneumatic actuator. According to one embodiment, the actuator has the following: a housing having a pressure chamber; a rod inserted into the pressure chamber of the housing from the outside; a rod seal which is located around the rod and seals the pressure chamber; and a rod guide which is mounted on the housing and is designed to guide the rod along the longitudinal axis thereof. There is no piston arranged in the pressure chamber. Rather, an unsealed annular gap is present inside the pressure chamber between the rod and an inner wall of the pressure chamber, so that a gas pressure prevailing in the pressure chamber can propagate in the entire pressure chamber as far as the rod seal.

### TECHNICAL FIELD

The present disclosure relates to the field of pneumatic actuators, in particular to a cost-effective design of a pneumatic linear actuator which can replace double-acting pneumatic cylinders in certain applications.

### BACKGROUND

There are different types of pneumatic actuators. Pneumatic cylinders in particular are used in a variety of applications. It is also known to use pneumatic actuators for closed-loop force control, for example, in automated, robot-assisted surface machining or, more generally, in applications where a robot is supposed to contact a surface “gently” (without impact) with a tool, for example. An example of a pneumatic handling device for use in industrial robots is described in U.S. Pat. No. 10,906,177. Known devices and systems contain, inter alia, bellows cylinders, pneumatic muscles or double-acting pneumatic cylinders, which makes such devices complex and expensive to manufacture. A requirement for such a handling device for robot-assisted surface machining is the ability to absorb bending moments.

The inventor has set himself/herself the aim of creating a pneumatic linear actuator which is inexpensive to produce and particularly suitable for applications in the field of robot-assisted surface machining.

### SUMMARY

A pneumatic actuating element is described. According to an exemplary embodiment, the actuating element comprises the following: a housing with a pressure chamber; a rod inserted from the outside into the pressure chamber of the housing; a rod seal arranged around the rod and sealing the pressure chamber; and a rod guide mounted on the housing and configured to guide the rod along its longitudinal axis. There is no piston arranged in the pressure chamber. Rather, inside the pressure chamber there is an unsealed annular gap between the rod and an inner wall of the pressure chamber, so that a gas pressure present in the pressure chamber can propagate throughout the entire pressure chamber up to the rod seal.

Further exemplary embodiments relate to handling devices or linear actuators with one or more of the pneumatic actuating elements mentioned.

### BRIEF DESCRIPTION OF THE DRAWINGS

In the following, various embodiments will be elucidated in greater detail with reference to examples illustrated in the figures. The illustrations are not necessarily to scale, and the embodiments are not limited to the illustrated aspects. Instead, value is placed on representing the principles on which the illustrated exemplary embodiments are based.

FIG. 1 is an exemplary schematic representation of a robot-assisted grinding device with a grinding machine which is coupled to an industrial robot by means of a force-controlled linear actuator; the linear actuator causes a partial mechanical decoupling of the industrial robot and the grinding machine.

FIG. 2 illustrates an example of a pneumatic linear actuator (handling device) in a side view.

FIG. 3 is a schematic longitudinal sectional representation of a first exemplary embodiment.

FIG. 4 is a schematic longitudinal sectional representation of a second exemplary embodiment.

FIG. 5 is a schematic longitudinal sectional representation of a third exemplary embodiment at medium deflection.

FIG. 6 illustrates the example from FIG. 5 with minimal deflection.

### DETAILED DESCRIPTION

In robot-assisted surface machining, a machine tool (e.g. a grinding machine, a drilling machine, a milling machine, a polishing machine and the like) is guided by a manipulator, for example an industrial robot. The machine tool can be coupled in different ways to the so-called end effector flange, the position of which determines the TCP (Tool Center Point) of the manipulator; the manipulator can generally adjust the position and the orientation of the TCP practically arbitrarily in order to move a machine tool along a trajectory, for example parallel to a surface of a workpiece. Industrial robots are typically position-controlled, enabling a precise movement of the TCP along the desired trajectory. However, the following applies not only to robot-assisted surface machining, but generally to robotic applications where a robot with a tool must contact a surface more or less gently (without impact). This can also apply to pick-and-place applications, for example.

In many applications, a closed-loop control of the process force (for example, a force when contacting a workpiece or a contact force during surface machining, such as a grinding force) is necessary, which is often difficult to achieve with sufficient accuracy using conventional industrial robots. The large and heavy arm segments of an industrial robot have too much inertia for a closed-loop controller to react quickly enough to fluctuations in the process force. To solve this problem, a linear actuator which is smaller (and lighter) than an industrial robot can be arranged between the end effector flange of the manipulator and the machine tool, which couples the end effector flange of the manipulator to the machine tool. During surface machining, the linear actuator regulates only the process force (i.e. the contact force between the tool and the workpiece), while the manipulator moves the tool or the machine tool together with the linear actuator along the desired trajectory in a position-controlled manner. By closed-loop force control, the linear actuator can compensate for inaccuracies in the position and the shape of the workpiece to be machined as well as inaccuracies in the trajectory of the manipulator (within certain limits). Nevertheless, there are robots which are able to adjust the process force using closed-loop force/torque control even without the linear actuator mentioned, although this is comparatively complex and expensive.

Before various exemplary embodiments are explained in detail, a general example of a robot-assisted grinding device is first described. It goes without saying that the concepts described here are also transferable to other types of surface machining (for example, polishing, milling, drilling, etc.) and not limited to grinding. As mentioned, the exemplary embodiments described here can be used as linear actuators (handling devices) in a wide variety of applications and generally represent a cost-effective alternative to linear actuators which are driven by pneumatic cylinders.

According to FIG. 1, a robot-assisted grinding device includes a manipulator 80, for example an industrial robot, and a grinding machine 50 with a rotating grinding tool 51, wherein the grinding machine 50 can be coupled to the end effector flange of the manipulator 1 via a linear actuator 20. The location (position and orientation) of the end effector flange also determines the TCP. Strictly speaking, the TCP is not a point, but a vector and can be described, for example, by three spatial coordinates (position) and three angles (orientation). In robotics, generalized coordinates (usually six joint angles of the robot) in the configuration space are also sometimes used to describe the position of the TCP. The position and the orientation of the TCP is also sometimes referred to as “pose”. The position (including the orientation) of the TCP as a function of time defines the movement of the grinding tool, which is referred to as the trajectory. The TCP is often defined as the center of the robot's end effector flange, but this is not necessarily the case. The TCP can be an arbitrary point (and can theoretically also be located outside the robot) whose position and orientation can be adjusted by the robot. The TCP can also define the origin of the tool coordinate system.

In the case of an industrial robot with six degrees of freedom, the manipulator 80 can be constructed from four segments 82, 83, 84 and 85, which are each connected via joints G₁₁, G₁₂ and G₁₃. The first segment 82 is usually rigidly connected to a stand 81 (which, however, does not necessarily have to be the case). The joint G₁ connects the segments 82 and 83. The joint G₁₁ can be 2-axis and enable a rotation of the segment 83 about a horizontal axis of rotation (elevation angle) and a vertical axis of rotation (azimuth angle). The joint G₁₂ connects the segments 83 and 84 and enables a pivoting movement of the segment 84 relative to the position of the segment 83. The joint G₁₃ connects the segments 84 and 85. The joint G₁₃ can be 2-axis and therefore enable (similarly to joint G₁₁) a pivoting movement in two directions. The end effector flange and thus also the TCP have a fixed relative position with respect to the segment 85, which usually also includes a swivel joint (not shown) which enables the end effector flange 86 arranged on the segment 85 to rotate about a longitudinal axis A of the segment 85 (shown as a dash-dotted line in FIG. 1, also corresponds to the axis of rotation of the grinding tool in the example shown). Each axis of a joint is assigned an actuator (for example, an electric motor) which can cause a rotational movement about the respective joint axis. The actuators in the joints are actuated by a robot controller 70 according to a robot program. Various industrial robots/manipulators and associated controllers are known per se and therefore not explained further here.

The manipulator 80 is usually position-controlled, i.e. the robot controller can determine the pose (location and orientation) of the TCP and move it along a predefined trajectory. In FIG. 1, the longitudinal axis of the segment 85, on which the TCP lies, is designated A. If the actuator 100 rests against an end stop, the pose of the end effector flange (or of the TCP) also defines the pose of the grinding machine 50 (and also of the tool/grinding wheel 51). As already mentioned at the beginning, the linear actuator 100 serves to adjust the contact force (process force) between the tool and the workpiece 60 to a desired value during the grinding process. A direct closed-loop force control by the manipulator 80 is generally too imprecise for grinding applications, since the high inertia of the segments 83 to 85 of the manipulator 80 makes it practically impossible to quickly compensate for force peaks (for example, when placing the grinding tool on the workpiece 60) with conventional manipulators. For this reason, the robot controller 70 is configured to regulate the pose (position and orientation) of the TCP of the manipulator 80, while the closed-loop force control is usually accomplished exclusively with the aid of the actuator 100.

As already mentioned, during the grinding process the contact force F_{K} between the grinding tool (grinding machine 50 with grinding wheel 51) and the workpiece 60 can be adjusted with the aid of the linear actuator 100 and a closed-loop force control (which can be implemented, for example, in the controller 70) so that the contact force F_{K} (in the direction of the longitudinal axis A) between the grinding wheel 51 and the workpiece 60 corresponds to a predeterminable target value. The contact force F_{K} is a reaction to the actuator force F_{A} with which the linear actuator 100 presses on the workpiece surface. If there is no contact between the workpiece 60 and the tool 51, the actuator 100 moves against an end stop (not shown because it is integrated in the actuator 100) due to the lack of contact force on the workpiece 60 and presses against it with a defined force. The closed-loop force control can be active continuously. In this situation (no contact), the actuator deflection is therefore maximum and the actuator 100 is in an end position. The defined force with which the actuator 100 presses against the end stop can be very small or (theoretically) even regulated to zero in order to enable contact with the workpiece surface as gently as possible.

The position control of the manipulator 80 can work completely independently of the closed-loop force control of the actuator 100 (which can also be implemented in the controller 70). The actuator 100 is not responsible for the positioning of the grinding machine 50, but only for adjusting and maintaining the desired contact force F_{K} during the grinding process and for detecting contact between tool 51 and workpiece 60. For example, a contact can be detected in a simple manner in that the actuator has moved out of the end position (actuator deflection is smaller than the maximum deflection at the end stop).

it goes without saying that the direction of action of the actuator 90 and the axis of rotation of the grinding machine 50 do not necessarily have to coincide with the longitudinal axis A of the segment 85 of the manipulator 80. In the case of a pneumatic actuator, the closed-loop force control can be implemented in a manner known per se with the aid of a control valve, a regulator (for example implemented in the controller 70) and a compressed air storage or compressor. Since the inclination to the vertical is relevant for taking gravity (i.e. the weight of the grinding machine 50) into account, the actuator 100 can contain an inclination sensor or this information can be determined based on the joint angles of the manipulator 80. The determined inclination is taken into account by the force regulator. The specific implementation of the closed-loop force controller is known per se and not important for the further explanation and it is therefore not described in more detail. The linear actuator 100 not only enables a certain mechanical decoupling between the manipulator 80 and the workpiece 60, it is also able to compensate for inaccuracies in the positioning of the TCP and/or of the workpiece.

In another type of robot-assisted surface machining, the machine tool is mounted on a stationary base via a linear actuator, while a conventional industrial robot brings a workpiece to the machine tool (for example a grinding machine) in a position-controlled manner. The closed-loop control of the process force is in turn accomplished by the linear actuator, while the robot can be position-controlled in a conventional manner. This means that, during the surface machining process, the linear actuator (supporting itself on the base) presses the machine tool against the workpiece, which is held at a defined position by the robot.

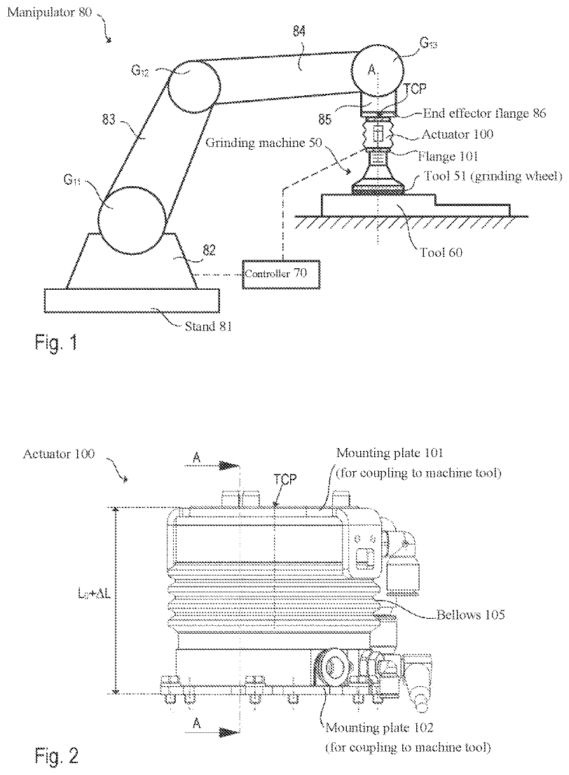

The linear actuator 100 is also referred to below as a handling apparatus. FIG. 2 illustrates an exemplary embodiment in a side view. According to FIG. 2, the device comprises two facing mounting plates 101 and 102 (mounting flanges), wherein the first mounting plate 101 is configured to mechanically couple the device to a tool (for example, a gripper) or a machine tool (for example, a grinding machine, a polishing machine, etc.), and wherein the second mounting plate 102 is configured to mechanically couple the device to the end effector flange 86 of a manipulator (see FIG. 1). For example, the second mounting plate 102 is mounted on the end effector flange 86 using screws. Likewise, the machine tool can be mounted on the first mounting plate 101 using screws. Alternative mounting options (clamps, bayonet lock, etc.) are possible.

The interior of the handling device located between the mounting plates 101, 102 is covered with a bellows 105 in the example shown. Said bellows essentially serves to keep dust and other contaminants away from the internal components of the device. Other cover designs are also possible.

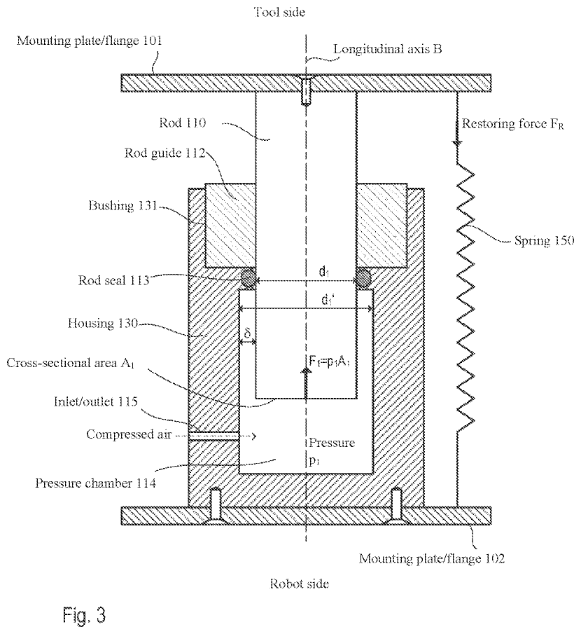

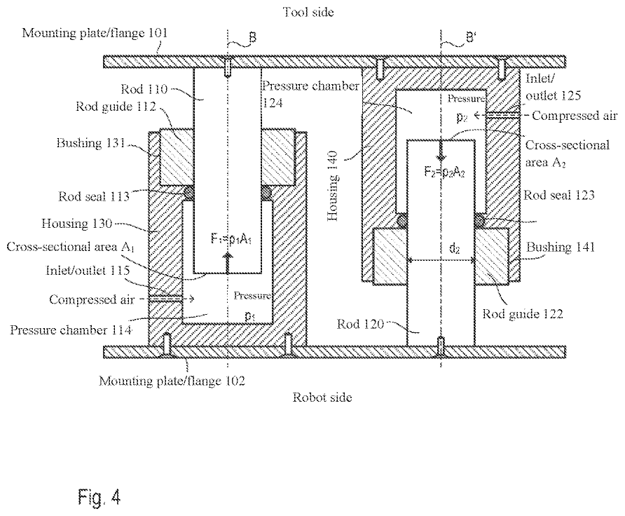

FIG. 3 illustrates a first example of the handling device described here using a schematic sketch. It should be emphasized in advance that this is not a conventional combination of piston and (pneumatic) cylinder, but rather simply a rod 110 guided in a rod guide 112, which is inserted into an interior of a housing 130. A common rod seal 113 seals the interior of the housing 130 along the circumference of the rod 110. That is, the rod seal 113 and the rod guide 112 are axially spaced apart (along the longitudinal axis B of the rod). The rod 110 is mounted in the rod guide 112 so that it can move along its longitudinal axis. In the example shown, the rod guide 112 is arranged in a bushing 131 arranged in the housing 130. For example, the rod guide 112 can be pressed into the bushing 131. Other techniques for attaching the rod guide 112 to or in the housing 130 are possible. The rod guide 112 may be or contain a recirculating ball guide. The rod guide is usually made of stainless steel. Various rod guides are known per se and commercially available and are therefore not discussed further here.

The rod guide 112 enables the rod 110 to move only in the longitudinal direction (along the longitudinal axis B) and can in particular absorb bending moments, i.e. torques about an axis normal/transverse to the longitudinal axis B. Rod guides are also used as wave guides, also referred to in particular as linear bearings. In an embodiment, a linear ball bearing is used as a rod guide. Linear ball bearings are also referred to as ball bushings and have the advantage that they cause a comparatively low (practically no) static friction between the bearing and the rod, which largely avoids a stick-slip effect.

When the rod 110 is moved, the volume of the interior of the housing 130 changes. The interior of the housing can be supplied with compressed air (see FIG. 3, inlet/outlet 115 for compressed air), which is why the interior is also referred to below as pressure chamber 114 (pressure p₁). The end face of the rod 110 located outside the housing 130 is connected to one of the mounting plates (in the example shown to the mounting plate/flange 101). The housing 130 is mounted on the other mounting plate (in the example shown, on the mounting plate/flange 102). The mechanical connections between rod 110 and mounting plate 101 and between housing 130 and mounting plate 102 can be made, for example, using screws. However, other connection techniques are also possible (for example, gluing, press connections, etc.).

At an (air) pressure p₁ in the pressure chamber 114, the force F₁ acting on the rod 110 (along its longitudinal axis B) is equal to p₁·A₁, where A₁=d₁²π/4. The pressure p₁ is usually an overpressure, i.e. higher than the atmospheric pressure outside the pressure chamber. The parameter d₁ denotes the diameter of the rod 110 in the pressure chamber 114, in particular the diameter of the rod 110 in the area of the rod seal 113. In the examples discussed here, the pressure chamber 114 has the shape of a cylinder with the inner diameter d₁′, with an (annular) gap δ present between the circumference of the rod 110 and the inner wall of the pressure chamber 114 (i.e. d₁′=d₁+2 δ). The force F₁ caused by the compressed air pushes the two mounting plates 101 and 102 apart against the effect of a restoring force F_{R} which can be generated by a spring 150, for example. In the example shown, the spring 150 also acts between the two mounting plates 101 and 102 and causes a restoring force F_{R} which is dependent on the movement ΔL (see FIG. 2) of the rod 110 (F_{R}≈k ΔL, where k denotes the spring constant). The minimum distance between the mounting plates 101 and 102, defined for example by an end stop, is L₀ (ΔL=0, see FIG. 2). The maximum distance between the mounting plates 101 and 102 can also be determined by an end stop. The end stops are not shown in FIG. 3. Instead of the spring 150, other restoring elements can also be used.

Unlike a conventional piston/cylinder combination, the pneumatically effective area is equal to the cross-sectional area of the rod 110 in the area of the rod seal 113. In the example shown, there is also no equivalent to a piston seal (which would move with the piston), but only the rod seal 113 mounted in the housing 130 (and not movable with the rod). Since there is no piston with a piston seal in the examples described here, the gas pressure p₁ present inside the housing 130 can propagate throughout the entire pressure chamber 114 (thus also into the annular gap δ) up to the rod seal 113. In contrast, a piston would divide the interior of the housing 130 into two pressure chambers, which is not the case in the examples described here. The housing 130 contains only a (single) pressure chamber 114. At the same time, rod guide 112 (linear bearing) ensures reliable absorption of bending moments with a compact and cost-effective design. In conventional actuators which use normal pneumatic cylinders, the linear guides which can accommodate significant bending moments are arranged separately next to (i.e. parallel to) the pneumatic cylinder.

The housing 130 can be made of plastic, for example, using an injection molding process or using additive manufacturing (3D printing). The material from which the housing 130 is made is more elastic (less rigid) than the material from which the rod guide is made (usually steel). In another example, the housing 130 is manufactured using aluminum die casting. Machining (for example by milling) is only necessary in the area of the bushing 131 and possibly on the surface which is connected to the mounting plate 102. Overall, the linear actuator according to FIG. 3 is essentially simpler and cheaper to manufacture than a linear actuator in which a conventional pneumatic cylinder is used as the actuating element.

In the example shown in FIG. 4, a further arrangement with a rod 120, a housing 140, a rod guide 122 and a rod seal 123 is provided. The left part in FIG. 4 is constructed in the same way as in the example from FIG. 3, and reference is made to the description above. The right part of the device in FIG. 4 is constructed analogously to the left part, but connected in the opposite way (upside-down) to the mounting plates 101, 102. The two actuating elements with the longitudinal axes B and B′ (each including a housing with rod guide and bar seal and a rod) are arranged so to speak in an antiparallel manner.

The represented arrangement with two rods is more stable in terms of absorbing bending moments and can generate higher forces. The two actuating elements can also be arranged parallel (instead of antiparallel). In this case, the right part of the device in FIG. 4 would be constructed the same as the left part and would be connected to the mounting plates 101, 102 in the same way. In some embodiments, more than two combinations of housing with pressure chamber, rod and rod guide are provided in order to increase the maximum actuator force (at the same pressure in the pressure chambers, the pneumatically effective end faces of the rods add up) and to increase the maximum possible bending moments.

The housing 140 of the second actuating element is connected to the mounting plate 101 (for example using of screws) and the end face of the rod 120 located outside the housing 140 is connected to the facing mounting plate 102 (for example also using a screw). The housing 140 has a socket 141 in which the rod guide 122 is arranged. The rod seal 123 is arranged (at an axial distance) adjacent to the rod guide 122 in the housing 140 (analogously to the housing 130 and the rod seal 113). The interior of the housing 140 forms a pressure chamber 124, the volume of which depends on the position of the rod 120. Compressed air (pressure p₂) can enter the pressure chamber 124 via the inlet/outlet 125. The force F₂ acting on the rod 120 is proportional to the pressure p₂ and to the pneumatically effective area A₂=d₂²π/4 (i.e. F₂=p₂·A₂).

In the example from FIG. 4, the combination of the second rod 120 and the second pressure chamber 124 arranged in the second housing 140 can function as a restoring element when the gas pressure p₂ in the second pressure chamber 124 is an underpressure. Underpressure means a pressure p₂ which is lower than the atmospheric pressure outside the device. A pressure chamber subjected to underpressure results in the respective combination of rod/housing/pressure chamber behaving practically like a spring which generates a restoring force. In this case, the closed-loop force control occurs by adjusting the (over)pressure in the respective other pressure chamber, since in practice overpressure can be regulated better than underpressure.

As already mentioned with reference to FIG. 3, in this example too, the pneumatically effective surfaces A₁ and A₂ are equal to the cross-sectional areas of the rods 110 and 120 in the area of the rod seals 113 and 123. The areas A₁ and A₂ can be the same. In contrast to conventional solutions, there is no need for piston seals. The rod seals 113 and 123 are arranged in the respective housings 130 and 140 and are not movable relative to the respective housings 130 and 140. A spring is not necessary in the example because the restoring force F₂ is generated pneumatically. Nevertheless, a spring (similar to that in FIG. 3) can also be provided.

As mentioned, the housings 130 and 140 may be made of a material which is more elastic (less rigid) than the material from which the rod guides 112, 122 are made (usually steel). For example, the housings 130 and 140 are made of plastic (injection molding) or aluminum (die casting). As mentioned, additive manufacturing processes (3D printing) are also possible. The relatively more elastic housing makes it possible to compensate for deviations from a perfect parallelism of the longitudinal axes B and B′ of the rods 110 and 120 respectively (within certain limits) and to prevent a fixing of the linear actuator. Deviations from a parallel alignment of the longitudinal axes B and B′may occur on the one hand due to production-related tolerances and on the other hand due to bending moments in operation.

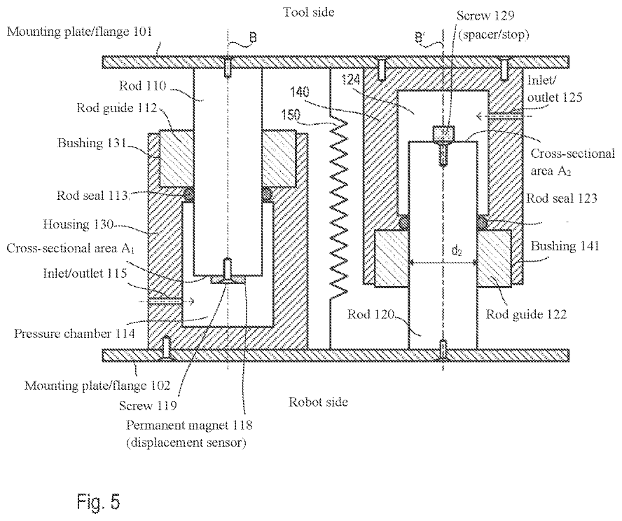

FIG. 5 illustrates a further exemplary embodiment, which is very similar to the example from FIG. 4. In terms of function, the exemplary embodiment from FIG. 5 essentially corresponds to the example from FIG. 4, wherein two antiparallel actuating elements are arranged between the mounting plates 101 and 102. In addition, a spring 150 is arranged between the two mounting plates 101, 102 as a restoring element, which brings the linear actuator/handling device into a defined end position, even if the pressure chambers 114 and 124 of the two actuating elements are not pressurized.

As in the previous example, the housings 130 and 140 comprise the bushings 131 and 141, respectively, for the rod guides 112 and 122. The rod seals 113 and 123 are arranged coaxially with respect to the rod guides 112, 122 in the respective housing. The two rods 110 and 120 are guided antiparallel in the rod guides 112 and 122. Depending on the rod position (i.e. depending on the deflection ΔL of the linear actuator), the volume of the pressure chambers 114 and 124 in the housing varies. In the situation shown in FIG. 5, the deflection ΔL is in a medium range. The maximum volume of the pressure chambers 114, 124 is defined by an end stop (not shown). The rod 110 is rigidly connected to the mounting plate 101 using the screw 111. Likewise, the rod 120 is connected to the mounting plate 102 using the screw 121. The associated housings 130 and 140 are firmly connected to the respective other mounting plate (for example screwed).

In the retracted state (i.e. with minimal deflection ΔL=0), the end faces of the rods 110 and 120 located inside the pressure chambers 114, 124 must not lie completely against the wall of the pressure chamber, otherwise there will no longer be any surfaces A₁ and A₂ available on which the pressure can act and exert a corresponding force p₁A₁ or p₂A₂. The screw 129 shown in FIG. 5 and screwed into the end face of the rod 120 forms an end stop for the retracted state. The screw 129 protrudes from the end face of the rod 110 and thus also forms a spacer, so that at least part of the cross-sectional area A₂ remains pneumatically effective and, even in the fully retracted state, a force can be exerted on the rod due to the pressure p₂ in the pressure chamber 124. Due to the mechanical coupling of the two rods 110, 120 and the associated housings 130, 140 to the mounting plates 101, 102, a spacer on the rod 110 is not absolutely necessary.

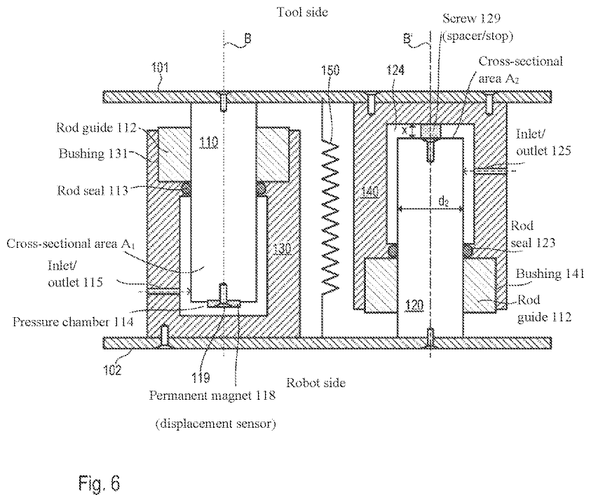

A permanent magnet 118, which is part of a magnetic displacement sensor (not shown in FIGS. 5 and 6), can be attached to the other rod (left rod 110) using a screw 119. The displacement sensor is configured to measure the deflection ΔL of the linear actuator. Various types of suitable magnetic and other displacement sensors are known per se and will therefore not be discussed further. Relevant to the example shown is the magnet 118 mounted on the rod 110 and moving with it, enabling a simple displacement measurement.

FIG. 6 shows the device from FIG. 5 in a fully retracted state (ΔL=0). It can be seen that the screw head of the screw 129 forms an end stop and rests against the wall of the pressure chamber 124 (facing the end face of the rod 120). Only the screw head of the screw 129 lies on the wall of the pressure chamber 124, but not the end face of the rod 120. In the position shown (ΔL=0), said end face is spaced a distance x from the facing wall of the pressure chamber 124. It goes without saying that the screw 129 can also be screwed into the facing wall surface of the pressure chamber 124 instead of into the end face of the rod 120. Instead of the screw 129, a spacer can also be molded directly onto the housing wall or the rod. Spacer and housing 140 may be one part (for example, a casting).

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although various embodiments have been illustrated and described with respect to one or more specific implementations, alterations and/or modifications may be made to the illustrated examples without departing from the spirit and scope of the appended claims. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the invention.

It will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-19. (canceled)

20. A device, comprising:
a first housing with a first pressure chamber;
a first rod introduced from the outside into the first pressure chamber;
a first rod seal arranged around the first rod and sealing the first pressure chamber, wherein inside the first pressure chamber, an unsealed annular gap is present between the first rod and an inner wall of the first pressure chamber so that a gas pressure present in the first pressure chamber can propagate throughout the entire first pressure chamber up to the first rod seal;
a first rod guide mounted on the first housing and configured to guide the first rod along a longitudinal axis of the first rod, wherein the first rod guide is spaced from the first rod seal; and
a restoring element arranged to counteract a force exerted on the first rod by the gas pressure.

21. The device of claim 20, wherein the first housing comprises a single pressure chamber, and wherein essentially the same pressure is present in the entire first pressure chamber.

22. The device of claim 20, further comprising:
a first mounting plate; and
a second mounting plate,
wherein the first mounting plate is firmly connected to the first rod,
wherein the first housing is firmly connected to the second mounting plate.

23. The device of claim 22, wherein the restoring element is configured to generate a pulling force between the first mounting plate and the second mounting plate.

24. The device of claim 20, wherein the first housing outside of the first pressure chamber comprises a bushing and the first rod guide is arranged in the bushing.

25. The device of claim 20, wherein the first rod seal is arranged in a groove of the first housing which extends around the first rod.

26. The device of claim 20, wherein the restoring element is a spring.

27. The device of claim 20, further comprising:
a second housing with a second pressure chamber;
a second rod introduced from the outside into the second pressure chamber;
a second rod seal arranged around the second rod and sealing the second pressure chamber, wherein inside the second pressure chamber, an unsealed annular gap is present between the second rod and an inner wall of the second pressure chamber so that a gas pressure present inside the second pressure chamber can propagate throughout the entire second pressure chamber up to the second rod seal; and
a second rod guide mounted in the second housing and configured to guide the second rod along a longitudinal axis of the second rod.

28. The device of claim 27, wherein the restoring element is formed by a combination of the second pressure chamber and the second rod, and wherein the gas pressure present in the second pressure chamber is an underpressure.

29. The device of claim 27, further comprising:
a first mounting plate; and
a second mounting plate,
wherein the first mounting plate is firmly connected to the first rod,
wherein the first housing is firmly connected to the second mounting plate,
wherein the second mounting plate is firmly connected to the second rod,
wherein the second housing is firmly connected to the first mounting plate.

30. The device of claim 27, further comprising:
a spacer serving as an end stop, which is arranged either on a face end of the first rod located in the first pressure chamber or on a wall of the second pressure chamber facing the end face of the first rod,
wherein the spacer, in a retracted end position of the device, ensures a distance between the end surface of the first rod and the facing wall of the first pressure chamber.

31. The device of claim 30, wherein the spacer is screwed into the first rod or the first housing, or wherein the spacer is an integral component of the first housing or of the first rod.

32. The device of claim 20, wherein the first housing is made of a material which is more elastic than a material from which the first rod is made.

33. A system, comprising:
a manipulator;
the device of claim 20 mounted on an end effector flange of the manipulator; and
a tool mounted on the device or a machine tool mounted on the device.

34. A system, comprising:
a manipulator configured to hold and position a workpiece;
the device of claim 20; and
a tool mounted on the device or a machine tool mounted on the device.

35. A pneumatic linear reactor, comprising:
a housing with a pressure chamber;
a rod introduced from the outside into the pressure chamber;
a rod seal arranged around the first rod and sealing the first pressure chamber, wherein inside the first pressure chamber, an unsealed annular gap is present between the rod and an inner wall of the pressure chamber so that a gas pressure present in the pressure chamber can propagate throughout the entire pressure chamber up to the rod seal;
a rod guide mounted on the housing and configured to guide the rod along a longitudinal axis of the rod and absorb bending moments; and
a restoring element arranged to counteract a force caused by the gas pressure on the rod.

36. The pneumatic linear reactor of claim 35, further comprising:
a spacer serving as end stop, which is arranged either on a face end of the rod located in the pressure chamber or on a wall of the pressure chamber facing the end face of the rod and ensuring, in a retracted end position of the actuating element, a distance between the end face of the rod and the facing wall of the pressure chamber.

37. The pneumatic linear reactor of claim 35, wherein the rod guide is a linear ball bearing or a ball bushing.

38. The pneumatic linear reactor of claim 35, wherein the rod guide is arranged in a bushing of the housing outside of the pressure chamber and spaced from the rod seal.
